(19) United States
(12) Patent Application Publication
(10) Pub. No.: US 2009/0031568 A1
(43) Pub. Date: Feb. 5, 2009

(54) Saw blade having helical structure

(76) Inventor: Chung Cheng Yang, Taichung Hsien (TW)

Correspondence Address: CHARLES E. BAXLEY, ESQUIRE, 90 JOHN STREET, SUITE 309, NEW YORK, NY, 10038, US

(21) Appl. No.: 11/888,458

(22) Filed: Jul. 31, 2007

(51) Int. Cl. B23D 61/12

(52) U.S. Cl. 30/353

(57) ABSTRACT

A saw blade includes an elongate and helical or flexible blade member having an outer peripheral cutting edge for allowing the blade member to be engaged into and engaged around a work piece without being maintained perpendicular to the work pieces and for allowing the blade member to be operated by the users. The blade member may include two elongate and planar blade elements superposed with each other and each having the cutting edge formed on the outer portion and extended out of an inner portion of the other blade elements for allowing the cutting edges of the blade elements to be exposed for easily working on or cutting the work pieces.

### BACKGROUND OF THE INVENTION

1. Field of the Invention

The present invention relates to a saw blade, and more particularly to a saw blade including a flexible and/or helical structure and including an outer peripheral cutting edge for allowing the saw blade to be tilted relative to the work pieces and for allowing the saw blade to easily cut the work pieces without being maintained or arranged perpendicular to the work pieces.

2. Description of the Prior Art

Typical saw blades comprise an elongate blade member having a cutting edge formed on one side edge of the blade member for working or cutting the work pieces.

For example, U.S. Pat. No. 5,684,388 to Theising et al., and U.S. Pat. No. 6,044,743 to O'Banion et al., and U.S. Pat. No. 6,393,957 to Wang disclose three of the typical scroll saw devices each also including a cutting edge formed on one side edge of the elongate blade member for working or sawing or cutting the work pieces.

However, due to the elongate and planar shape of the blade member, the blade member should be maintained or arranged perpendicular to the work pieces, otherwise, the blade member may have a good chance to be broken or damaged while sawing or cutting the work pieces.

U.S. Pat. No. 5,048,389 to Carlton discloses a typical circular saw blade with saw chain providing cutter links coupled between or within chains.

However, similarly, the blade members or the cutter links should also be maintained or arranged perpendicular to the work pieces, otherwise, the blade members or the cutter links may have a good chance to be broken or damaged while sawing or cutting the work pieces.

The present invention has arisen to mitigate and/or obviate the afore-described disadvantages of the conventional saw blades or circular saw blades.

### SUMMARY OF THE INVENTION

The primary objective of the present invention is to provide a saw blade including a flexible and/or helical structure and including an outer peripheral cutting edge for allowing the saw blade to be tilted relative to the work pieces and for allowing the saw blade to easily cut the work pieces without being maintained or arranged perpendicular to the work pieces.

In accordance with one aspect of the invention, there is provided a saw blade comprising an elongate and helical blade member including an outer peripheral cutting edge formed therein for allowing the blade member to be engaged into and engaged around a work piece without being maintained perpendicular to the work pieces.

The blade member includes two elongate and planar blade elements superposed with each other and each having the cutting edge formed thereon.

The cutting edges are formed on an outer portion of the blade elements respectively and extended out of an inner portion of the other blade elements. The blade elements are twisted to form the blade member.

The blade member includes two end portions, and two hand grips attached to the end portions of the blade member respectively.

The blade member includes two end fittings attached to the end portions of the blade member for coupling to the hand grips respectively. The blade member includes two links coupled between the end fittings and the hand grips respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a saw blade in accordance with the present invention;

FIG. 2 is an enlarged partial perspective view of the saw blade;

FIG. 3 is a plan schematic view illustrating the members or materials for forming or making the saw blade;

FIG. 4 is a plan schematic view illustrating the formation of the saw blade;

FIGS. 5, 6 are plan schematic views illustrating the operation of the saw blade; and

FIGS. 7, 8 are enlarged partial plan schematic views of the saw blade as shown in FIGS. 5, 6 respectively.

### DETAILED DESCRIPTION OF THE PREFERRED EMBODIMENT

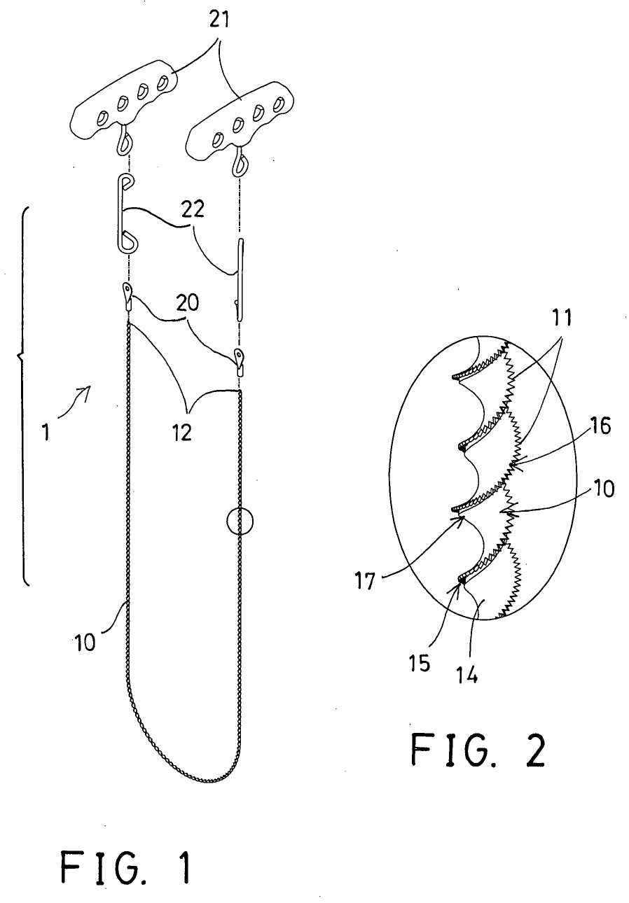

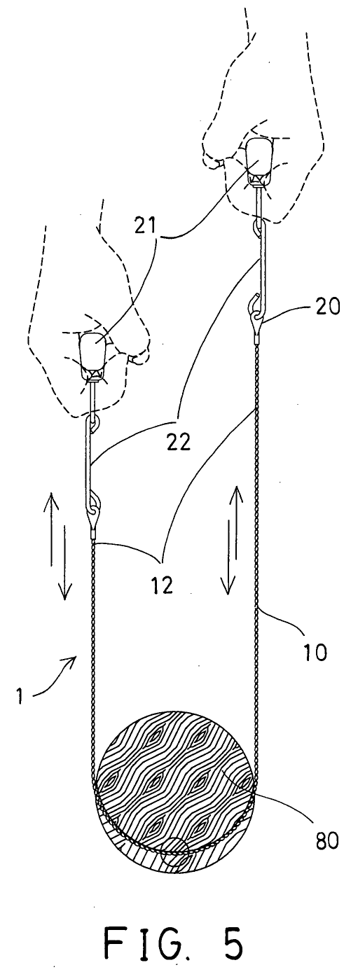

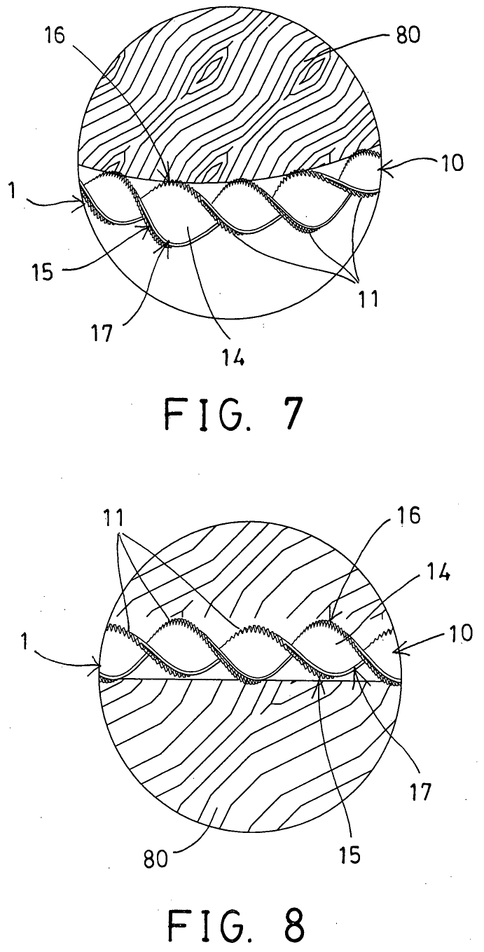

Referring to the drawings, and initially to FIGS. 1 and 2, a saw blade 1 in accordance with the present invention comprises an elongate blade member 10 including a flexible structure and/or a helical structure and including an outer peripheral cutting edge 11 formed in the outer peripheral portion thereof (FIGS. 2, 4, 7-8) for allowing the helical or flexible blade member 10 to be engaged into or engaged around the work pieces 80 (FIGS. 5-8) without being maintained or arranged perpendicular to the work pieces 80. The elongate blade member 10 may include two end portions 12 (FIGS. 1, 5, 6).

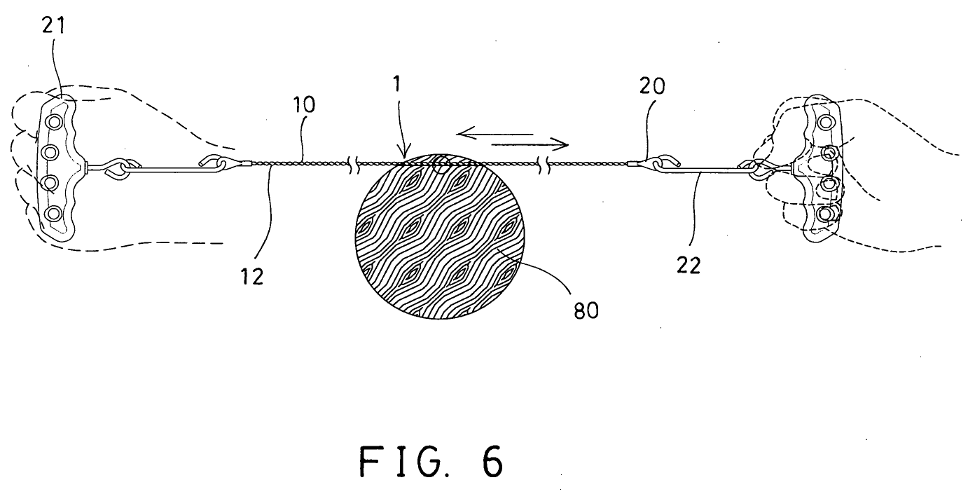

Two couplers or end fittings 20 may be solidly attached or engaged or secured to the end portions 12 of the elongate blade member 10 respectively (FIGS. 5, 6) with such as fasteners or latches (not shown), or with clamping procedures, welding processes, or the like, for coupling to two handles or hand grips 21 with hooks or links 22 for allowing the hand grips 21 to be attached to the end portions 12 of the elongate blade member 10 respectively and for allowing the elongate blade member 10 to be pulled or actuated by the users and for allowing the elongate blade member 10 to be easily and readily operated by the users to work on or to cut the work pieces 80.

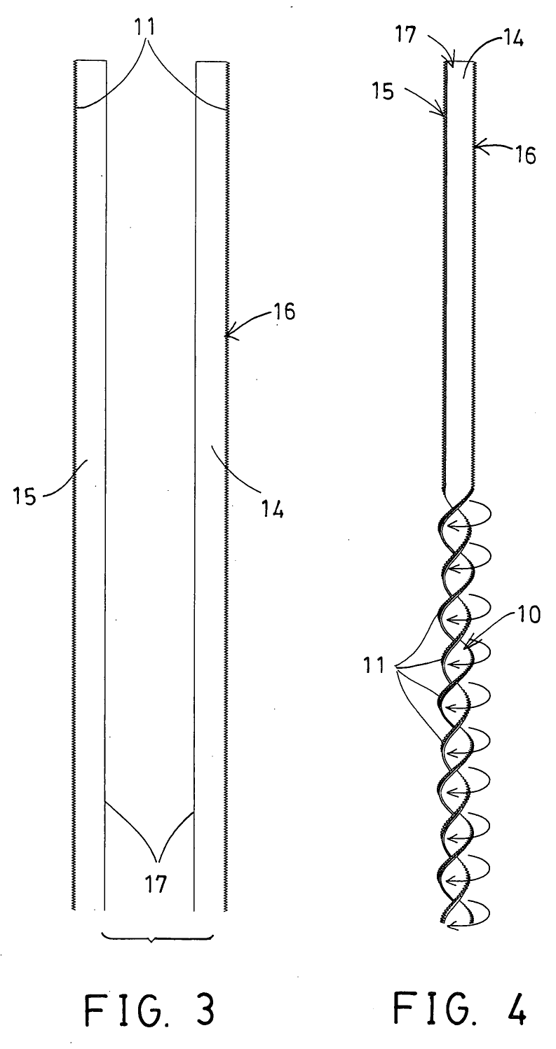

As shown in FIGS. 3 and 4, the elongate blade member 10 may be formed by or may include two elongate and planar blade elements 14, 15 superposed with each other and secured together with such as fasteners or latches (not shown), or with clamping procedures, welding processes, or the like, and may include the cutting edge 11 formed in the outer portion 16 thereof and extended out or beyond the inner portion 17 of the other blade elements 15, 14 for allowing the cutting edges 11 of the blade elements 14, 15 to be exposed for working on or cutting the work pieces 80, best shown in FIGS. 2, 4, 7, 8).

As best shown in FIG. 4, the superposed and/or secured blade elements 14, 15 of the elongate blade member 10 may then be twisted to form the helical structure of the elongate blade member 10 and to form the flexible structure to the elongate blade member 10 and thus for allowing the elongate and helical blade member 10 to be engaged around the work pieces 80 and to be easily engaged into the work pieces 80 without being maintained or arranged perpendicular to the work pieces 80. The typical saw blades failed to provide a helical blade member 10 having an outer peripheral cutting edge 11 formed in the outer peripheral portion thereof for cutting purposes.

Accordingly, the saw blade in accordance with the present invention includes a flexible and/or helical structure and including an outer peripheral cutting edge for allowing the saw blade to be tilted relative to the work pieces and for allowing the saw blade to easily cut the work pieces without being maintained or arranged perpendicular to the work pieces.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A saw blade comprising:
an elongate and helical blade member including an outer peripheral cutting edge formed therein for allowing said blade member to be engaged into and engaged around a work piece without being maintained perpendicular to the work pieces.

2. The saw blade as claimed in claim 1, wherein said blade member includes two elongate and planar blade elements superposed with each other and each having said cutting edge formed thereon.

3. The saw blade as claimed in claim 2, wherein said cutting edges are formed on an outer portion of said blade elements respectively and extended out of an inner portion of the other blade elements.

4. The saw blade as claimed in claim 2, wherein said blade elements are twisted to form said blade member.

5. The saw blade as claimed in claim 1, wherein said blade member includes two end portions, and two hand grips attached to said end portions of said blade member respectively.

6. The saw blade as claimed in claim 5, wherein said blade member includes two end fittings attached to said end portions of said blade member for coupling to said hand grips respectively.

7. The saw blade as claimed in claim 6, wherein said blade member includes two links coupled between said end fittings and said hand grips respectively.
